(19) United States
(12) Patent Application Publication
(10) Pub. No.: US 2013/0194150 A1
(43) Pub. Date: Aug. 1, 2013

(54) ANTENNA OF A LAPTOP DEVICE AND METHODS

(71) Applicant: Heikki Korva, Tupos (FI)

(72) Inventor: Heikki Korva, Tupos (FI)

(21) Appl. No.: 13/697,343

(22) PCT Filed: May 11, 2011
(86) PCT No.: PCT/FI2011/050434

§ 371 Date: Mar. 8, 2013

(30) Foreign Application Priority Data
May 12, 2010 (FI) 20105519

(51) Int. Cl. H01Q 1/48

(52) U.S. Cl. CPC H01Q 1/48
USPC 343/848

(57) ABSTRACT

An antenna of a laptop device, which can be connected wirelessly to a communication network. The apparent size of the antenna's ground plane (GND), as ‘seen’ from the feed of the monopole radiator (410), is reduced so that the outer peak of the strength of the electric field in the near field of the ground plane falls about at the distance of a quarter wavelength from the outer end of the radiator at the frequencies in the lower operating band of the antenna. This is implemented by arranging a quarter wave resonator (420, GND) tied to the ground plane so that the short-circuited end of this resonator is close to the outer end of the radiator. The capability of the antenna at the frequencies below 1 GHz improves because of the more favourable distribution of the field of the ground plane.

The invention relates to an antenna of a portable computer which can be connected wirelessly to a communication network.

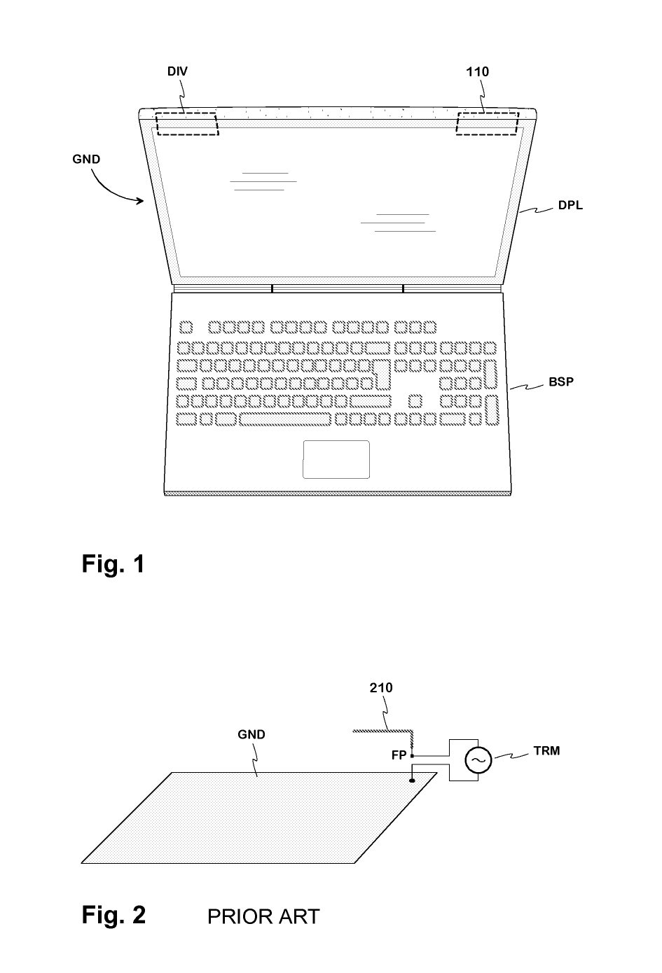

Portable computers are in practice foldable by model, for which reason they are called laptop device in this description and claims. In accordance with FIG. 1, a laptop device comprises a basic part BSP and display part DPL, which connect to each other by a hinge. When using the device, the display part is turned up, whereupon the keyboard is revealed in the basic part. Nowadays a wireless network connection can generally be established from the portable computers, in which case they naturally include also an antenna. The radiator 110 of the antenna is in most cases placed at the upper edge of the display part DPL, because it is then in as free a space as possible and therefore in the best position from the point of view of the radio connection. Inside the display part there is a large conductor surface which functions as the signal ground and electric shield of the electronic circuits and also as the ground plane GND of the antenna at the same time. Space diversity is commonly utilized in the devices to improve the reliability of the radio connection. For this reason a second radiator DIV is visible in FIG. 1 in the opposite upper corner of the display part. A diversity antenna for the antenna based on the radiator 110 is implemented by means of the second radiator.

In FIG. 2 there is a simple presentation of a known antenna of the laptop device. It comprises the ground plane GND in the display part of the device and a radiator 210 close to the ground plane. A radio transmitter TRM is coupled to the antenna by a transmission line, one conductor of which is connected to the radiator in its feed point FP and the other conductor is connected to the ground plane.

The ground plane GND of the antenna has naturally a high effect on the antenna's function. When the antenna resonates at one of its use frequencies, an own near field arises for the ground plane, which field has a certain shape. It depends on the size and shape of the ground plane and the antenna's use frequency, how well the field pattern of the ground plane and the field pattern of the radiator cohere so that the antenna would function as efficiently as possible.

If a laptop device must have an operating band below the frequency of 1 GHz, the implementation of this band is in practice more problematic than the one of the higher operating bands. This is firstly due to the fact that at these frequencies the electric size of the radiator tends to be too small because of the limited space available. The flaw caused by this could in principle be alleviated by shaping the ground plane optimal for the antenna. However, in the display part of a laptop device the ground plane has to have the same extent as the whole display for the function of the display itself. If the width of the ground plane is e.g. 25 cm, its field pattern is unfavourable for the radiator, which is located near a corner of the ground plane, inside the display part. The width of the lower operating band and the efficiency of the antenna in its range are not as good as desired. These are disadvantages of the known antennas represented by FIG. 2. In very small laptop devices, where the width of the ground plane is 13-15 cm, the antenna functions better. In them the energy of the near field of the ground plane concentrates closer to the radiator, thus supporting its function.

An object of the invention to reduce said drawbacks of the prior art. An antenna according to the invention is characterized by what is set forth in the independent claim 1. Some advantageous embodiments of the invention are disclosed in the other claims.

The basic idea of the invention is as follows: A monopole radiator is used in the antenna of a laptop device. The apparent size of the antenna's ground plane, as ‘seen’ from the feed of the radiator, is reduced so that the outer peak of the strength of the electric field in the near field of the ground plane falls about at the distance of a quarter wavelength from the outer end of the radiator at the frequencies in the lower operating band of the antenna. This is implemented by arranging a quarter wave resonator tied to the ground plane so that the short-circuited end of this resonator is close to the outer end of the radiator.

An advantage of the invention is that the capability of the antenna at the frequencies below 1 GHz is higher than of the corresponding known antennas. This is due to the above-mentioned resonator arrangement, which enhances the antenna's efficiency and widens the operating band. A further advantage of the invention is that its practical implementation is very simple thus causing no significant rise in the production costs.

The invention is described in detail in the following. In the description, reference is made to the accompanying drawings in which

FIG. 1 presents generally the antenna arrangement in a laptop device;

FIG. 2 presents as a principal drawing the antenna of a laptop device according to the prior art;

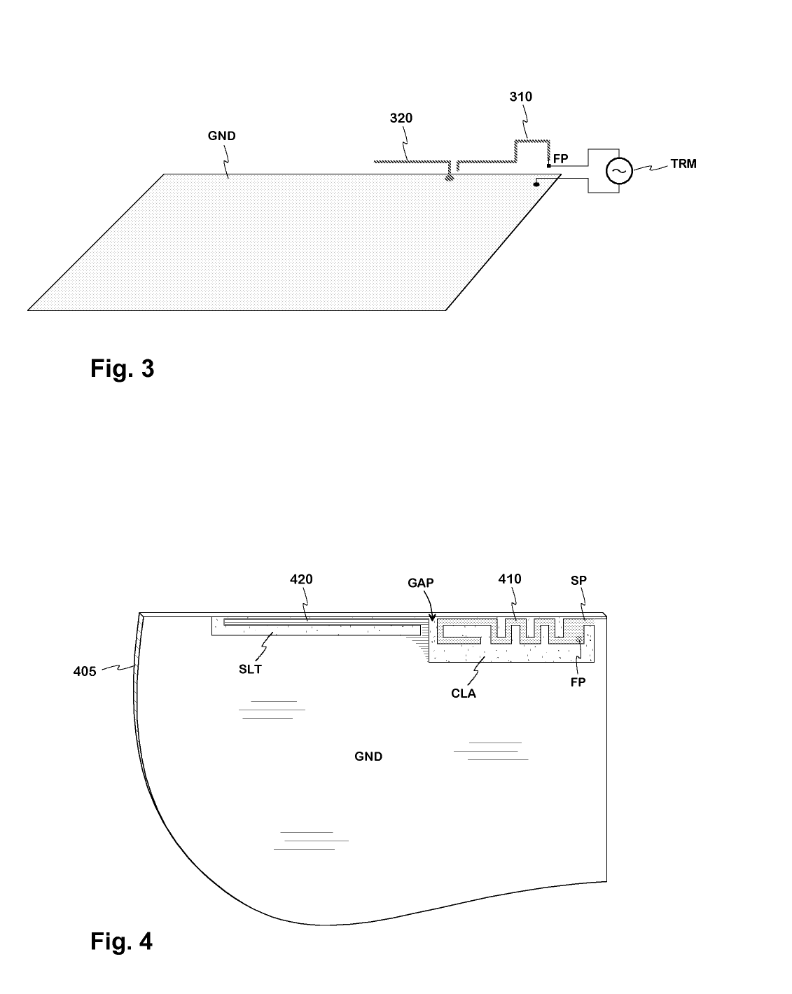

FIG. 3 presents as a principal drawing the antenna of a laptop device according to the invention;

FIG. 4 presents a practical example of the antenna of a laptop device according to the invention;

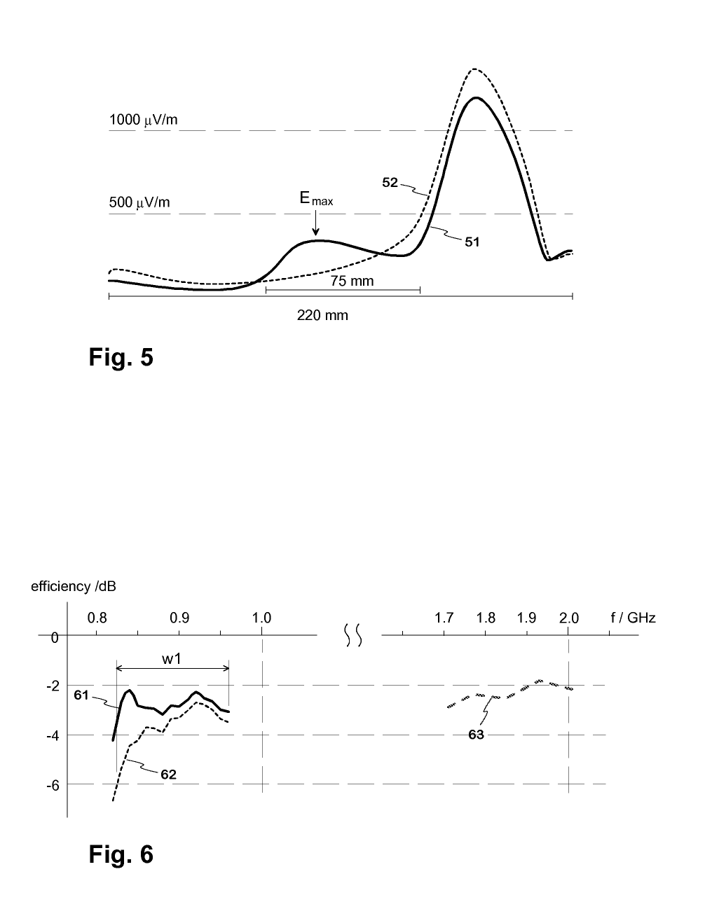

FIG. 5 presents an example of the fluctuation of the electric field in the near field of the ground plane of an antenna according to the invention;

FIG. 6 presents an example of the efficiency of an antenna according to the invention; and

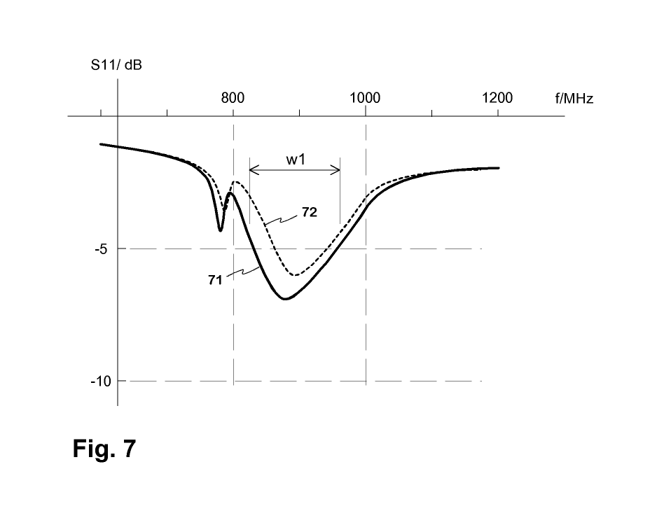

FIG. 7 presents an example of the matching of an antenna according to the invention in the lower operating band.

FIGS. 1 and 2 were already described in connection with the description of prior art.

In FIG. 3 there is a principal presentation of the antenna of a laptop device according to the invention. It comprises a ground plane GND, a monopole radiator 310 and a ground element 320, which are located in the display part of the device. A radio transmitter TRM is coupled to the antenna by a transmission line, one conductor of which is connected to the radiator in its feed point FP and the other conductor to the ground plane. The antenna's radiator is arranged so that the antenna has an operating band at least below the frequency 1 GHz. This band is called the lower operating band.

The ground element 320 is a conductor, which joins galvanically the ground plane from its one end. This short-circuited end of the ground element is close to the outer end of the radiator 310, or the radiator part, which is farthest off the feed point FP. ‘Close to’ means a distance, which is very short compared with the wavelength corresponding to the frequencies in the lower operating band, for example 1-2% of that wavelength. Starting from its short-circuit point, the ground element is directed away from the radiator and is dimensioned so that the strength of the electric field in the near field of the ground plane GND has a maximum about at the distance of a quarter wavelength from the outer end of the radiator at the frequencies in the lower operating band of the antenna. This means that the apparent size of the ground plane, affecting at the feed end of the radiator, reduces compared with an antenna according to FIG. 2 so that the antenna radiates more efficiently. It can be considered that the ground element forms together with the ground plane a quarter wave resonator, which receives its feed from the resonator based on the radiator.

FIG. 4 shows a practical example of the antenna of a laptop device according to the invention. An area in the upper corner of the device's display part, on which the antenna is located, is visible in the figure. When looking from the corner in the direction of the upper edge of the display part there is first the radiator 410 of the antenna and then the ground element 420. Both of them, as well as the ground plane GND, are of conductive coating of the dielectric plate 405 belonging to the display part. The feed end of the radiator is its end which is located nearer the corner of the display part. In the feed end there are the feed point FP of the antenna and in this example also a short-circuit point SP of the radiator, from which point the radiator joins the ground plane. In the example the radiator 410 is mainly meander-shaped. In addition, the radiator has a tail portion, which is directed from the outer end of the radiator back towards the feed point FP. To optimize the characteristics of the antenna, the edge of the ground plane is at some distance off the radiator so that an uncoated area CLA is round the radiator, the area being clearly larger than the radiator.

The ground element 420, peculiar to the invention, starts from the ground plane GND near the outer end of the radiator. After a short first portion, which joins the ground plane, the ground element comprises a straight conductor strip along the edge of the dielectric plate 405. This strip is separated from the ground plane by a slot SLT, the width of which is e.g. 8 mm. The width can naturally be different in different antennas varying for example in the range of 4-12 mm. A gap remains between the first portion of the ground element and the outer end of the radiator, the width of the gap being e.g. in the range of 3-8 mm.

FIG. 5 shows an example of the fluctuation of the electric field in the near field of the ground plane in an antenna according to the invention. The extent of the ground plane in the display part of the laptop device used in the example is 220 mm×145 mm, the width first-mentioned. The length of the ground element according to the invention in the antenna is 75 mm. The position of the ground element in the lateral direction and its length are marked in FIG. 5. Curve 51 shows the fluctuation of the electric field in the near field of the ground plane at the upper edge of the ground plane, and curve 52 for comparison the fluctuation of the electric field in the near field of the ground plane in the corresponding known antenna, which does not include the ground element. The curves are valid at the frequencies of the lower operating band. It appears from them that the electric field of the ground plane has in both cases a maximum at the middle part of the radiator. In the known antenna there is another maximum on the opposite side of the ground plane, as seen from the radiator. Instead, in the antenna according to the invention another maximum arises at the ground element, roughly the length of the quarter wave off the outer end of the radiator. The apparent size of the ground plane reduces so that its width is about the length of the half wave. This arrangement has an effect, which intensifies the radiation and receiving of the antenna, which matter is seen from the efficiency curves in FIG. 6.

FIG. 6 shows an example of the efficiency of an antenna according to the invention. The same antenna, to which the curve 51 in FIG. 5 relates, is in question. The lower operating band of the antenna is intended to cover the frequency range W1 used by the systems GSM850 and GSM900 in all, the range being 824-960 MHz. Curve 61 shows the fluctuation of the efficiency in the frequency range w1 and curve 62 for comparison the fluctuation of the efficiency of the corresponding known antenna, which does not include the ground element. It is seen from the curves that by means of the invention the efficiency improves at the lower end of range w1, at the frequencies 824-880 MHz, no less than about 2 dB. Upwards therefrom the advantage decreases, but is still typically about 0.5 dB. The absolute value of the efficiency is on average about −3 dB, which is valid in free space.

Curve 63 shows the efficiency of said antenna in the higher operating band. There the efficiency is on average about −2.3 dB. The effect of the arrangement according to the invention is very tow in the higher operating band.

FIG. 7 shows an example of the matching of an antenna according to the invention in the lower operating band. The example relates to the same antenna as the curves 51 and 61 in FIGS. 5 and 6. Curve 71 shows the fluctuation of the reflection coefficient S11 as the function of frequency, and curve 72 shows for comparison the fluctuation of the reflection coefficient in the corresponding antenna, which does not include a ground element according to the invention. It is seen from the curves that by means of the invention the reflection coefficient improves in the range w1 on average about one desibel. This means also widening of the band.

An antenna according to the invention has been described above. In the details, the structure of the antenna can naturally differ from what is presented. In the examples the antenna is located in the upper corner of the display part, but can be located also in another part of the display part, close to its edge. The shape of the antenna's radiator can vary widely, and in addition a parasitic element can be next to it. Also the shape of the ground element can vary, and it can stand proud of the ground plane. The ground element can be directed also a little downwards, when the display part is vertical. The inventive idea can be applied in different ways within the scope set by the independent claim 1.

1.-6. (canceled)

7. An antenna of a portable wireless device, comprising:
a ground plane;
a radiator disposed adjacent the ground plane and having a feed end and an outer end; and
a ground element, the ground element being galvanically coupled with the ground plane.

8. The antenna of claim 7, wherein the ground element is galvanically coupled to the ground plane at the outer end of the radiator.

9. The antenna of claim 8, wherein the feed end of the radiator is disposed near a corner of the portable device with the outer end being disposed near an outer edge of the portable device but inward of the corner.

10. The antenna of claim 7, wherein the ground element in combination with the ground plane forms a quarter wave resonator.

11. The antenna of claim 7, wherein the radiator comprises a meander-shaped radiator.

12. The antenna of claim 7, wherein:
the ground element as well as the ground plane comprises a conductive coating of a dielectric plate belonging to a display part of the portable device; and
a slot remains between the ground element and the ground plane on a surface of the dielectric plate.

13. The antenna of claim 12, wherein the width of said slot is between 4 and 12 mm inclusive.

14. The antenna of claim 7, wherein the radiator and the ground plane comprises a conductive coating of a dielectric plate belonging to a display part of the portable device, an edge of the ground plane being at a certain distance from the radiator;
wherein an uncoated area exists around the radiator, the uncoated area being larger than the radiator.

15. The antenna of claim 7, wherein the radiator is shaped to resonate in the frequency range on the order of about 2 GHz to implement a higher operating band for the antenna.

16. An antenna of a laptop device, comprising:
a ground plane;
a radiator disposed proximate the ground plane and having a feed end and an outer end; and
a ground element, the ground element comprising a short-circuit point, the short-circuit point being disposed adjacent the outer end.

17. The antenna of claim 16, wherein the ground plane, the radiator and the ground element are disposed along a planar dielectric plate.

18. The antenna of claim 17, wherein the ground element comprises a straight conductor strip.

19. The antenna of claim 18, wherein a slot is disposed between the ground element and the ground plane on a surface of the planar dielectric plate.

20. The antenna of claim 19, wherein the width of said slot is 4-12 mm.

21. An antenna for use in a laptop device, the antenna being located close to an edge of a display part (DPL) of the laptop device and having a lower operating band below a frequency of 1 GHz, the antenna comprising:
a ground plane;
a monopole radiator, residing within the same plane as the ground plane, with a feed end and an outer end;
wherein the antenna further comprises, in the same plane with the ground plane, a ground element which joins galvanically with the ground plane near the outer end of the monopole radiator, and which is directed substantially away from the outer end of the monopole radiator so as to reduce the apparent size of the ground plane affecting the feed end of the monopole radiator at one or more frequencies in the lower operating band of the antenna.

22. An antenna according to claim 21, wherein the ground element as well as the ground plane comprises a conductive coating of a dielectric plate belonging to the display part, in which case a slot remains between the ground element and the ground plane on a surface of the dielectric plate.

23. An antenna according to claim 22, wherein the width of said slot is between 4 and 12 mm inclusive.

24. An antenna according to claim 21, wherein the width of a gap between a short-circuited end of the ground element and an outer end of the radiator is between 3 and 8 mm inclusive.

25. An antenna according to claim 21, wherein at least portions of the radiator and the ground plane comprise a conductive coating of a dielectric plate belonging to the display part, an edge of the ground plane being at a certain distance from the radiator, and forming an uncoated area exists around the radiator, the uncoated area being larger than the radiator.

26. An antenna according to claim 21, wherein the radiator is shaped to resonate in the frequency range on the order of about 2 GHz to implement a higher operating band for the antenna.

27. A mobile device antenna, comprising:
a signal feed;
a ground plane; and
a radiator coupled to the feed and having a first operating band, the radiator configured such that an apparent size of the ground plane presented to the feed is minimized so that an outer peak of electric field strength in a near field of the ground plane is disposed approximately at a distance of one-quarter wavelength from an outer end of the radiator at one or more frequencies within the first operating band.

28. The antenna of claim 27, wherein:
the radiator comprises a monopole radiator; and
the first operating band comprises a low operating band of the antenna, the antenna having at least one second operating band which is higher in frequency than the first operating band.
